(19) United States
(12) Patent Application Publication
(10) Pub. No.: US 2004/0054534 A1
(43) Pub. Date: Mar. 18, 2004

(54) Client-server voice customization

(76) Inventor: Jean-Claude Junqua, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/242,860

(22) Filed: Sep. 13, 2002

(51) Int. Cl. G10L 13/00

(52) U.S. Cl. 704/258

(57) ABSTRACT

A user customizes a synthesized voice in a distributed speech synthesis system. The user selects voice criteria at a local device. The voice criteria represents characteristics that the user desires for a synthesized voice. The voice criteria is communicated to a network device. The network device generates a set of synthesized voice rules based on the voice criteria. The synthesized voice rules represent prosodic aspects and other characteristics of the synthesized voice. The synthesized voice rules are communicated to the local device and used to create the synthesized voice.

### FIELD OF THE INVENTION

The present invention relates to customizing a synthesized voice in a client-server architecture, and more specifically relates to allowing a user to customize features of a synthesized voice.

### BACKGROUND OF THE INVENTION

Text-to-Speech (TTS) synthesizers are a recent feature made available to mobile devices. TTS synthesizers are now available to synthesize text in address books, email, or other data storage modules to facilitate the presentation of the contents to a user. It is particularly beneficial to provide TTS synthesis to users of devices such as mobile phones, PDA's, and other personal organizers due to the typically small display size available to such devices.

Because of the progress of voice synthesis, the ability to customize a synthesized voice for personal applications is an area of growing interest. Customizing a synthesized voice is difficult to perform entirely within a mobile device because of the resources required. However, a remote server is capable of performing the required functions and transmitting the results to the mobile device. With the customized voice located on the mobile device itself, it becomes unnecessary for a user to be online to utilize the synthesized voice feature.

One method is available for performing voice synthesis according to a particular tone or emotion a user wishes to convey. A user can select voice characteristics to modulate the conversion of the user's own voice before the voice is transmitted to another user. Such a method does not allow a user to customize a synthesized voice, however, and is limited to amalgamations of the user's own voice. Another method uses a base repertoire of voices to derive a new voice. The method interpolates known voices to generate a new voice based on characteristics of the known voices.

### SUMMARY OF THE INVENTION

A method for customizing a synthesized voice in a distributed speech synthesis system is disclosed. Voice criteria are captured from a user at a first computing device. The voice criteria represent characteristics that the user desires for a synthesized voice. The captured voice criteria are communicated to a second computing device which is interconnected to the first computing device via a network. The second computing device generates a set of synthesized voice rules based on the voice criteria. The synthesized voice rules represent prosodic aspects and other characteristics of the synthesized voice. The synthesized voice rules are communicated to the first computing device and used to create the synthesized voice.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a method for selecting customized voice features;

FIG. 2 illustrates a system for selecting intuitive voice criteria according to geographic location;

FIG. 3 illustrates the distributed architecture of the customizable voice synthesis; and

FIG. 4 illustrates the distributed architecture for generating transformation data.

### DETAILED DESCRIPTION OF THE PREFERRED EMBODIMENTS

The following description of the preferred embodiments is merely exemplary in nature and is in no way intended to limit the invention, its application, or uses.

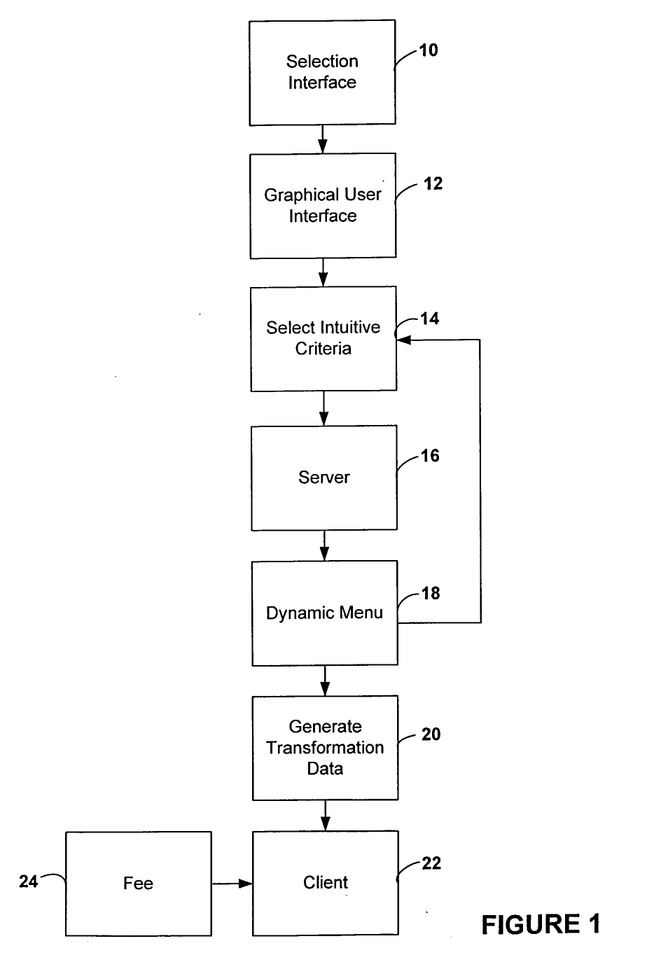

FIG. 1 illustrates a method for a user to select voice features to customize synthesized voice output. Various data typically presented to the user as text on a mobile device, such as email, text messages, or caller identification, is presented to the user as synthesized voice output. The user may desire to have the output of the TTS synthesis to have certain characteristics. For example, a synthesized voice which sounds energetic or excited may be desired for announcing new text or voicemail messages. The present invention allows the user to navigate a progression of intuitive criteria to customize the desired synthesized voice.

The user accesses a selection interface in step 10 on the mobile device to customize TTS output. The selection interface may be a touchpad, a stylus, or touchscreen, and is used to traverse a GUI (graphical user interface) on the mobile device in step 12. The GUI will typically be provided through a network client, which is implemented on the mobile device. Alternatively, the user may interact with the mobile device using verbal commands. A speech recognizer on the mobile device interprets and implements the verbal commands.

The user can view and choose an assortment of intuitive criteria for voice customization using the selection interface in step 14. The intuitive criteria are displayed on the GUI for the user to view. The criteria represent the positions of a synthesized voice in a multidimensional space of possible voices. Selection of criteria identify the specific position of the target voice in the space of voices. One possible criterion may be the perceived gender of the synthesized voice. A masculine voice may be relatively deep and have a low pitch, while a more feminine voice may have a higher pitch with a breathy undertone. The user may also select a voice that is not identifiably male or female.

Another possible criterion may be the perceived age of the synthesized voice. A voice at the young extreme of the spectrum has higher pitch and formant values. Additionally, certain phonemes may be mispronounced to further give the impression that the synthesized voice belongs to a younger speaker. In contrast, a voice at the older end of the spectrum may be raspy or creaky. This could be accomplished by making the source frequency aperiodic or chaotic.

Still other possible criteria relate to the emotional intensity of the synthesized voice. The appearance of high emotional intensity may be achieved by increasing stress on specific syllables in an uttered phrase, lengthening pauses, or speeding up consecutive syllables. Low emotional intensity could be achieved by generating a more neutral or monotone synthesized voice.

One problem with voice synthesis of unknown text is reconciling the desired emotion with the prosody contained in a message. Prosody refers to the rhythmic and intonational aspects of a spoken language. When a human speaker utters a phrase or sentence, the speaker will usually, and quite naturally, place accents on certain words or phrases, to emphasize what is meant by the utterance. Changes in emotion may also require changes in the prosody of the voice in order to accurately represent the desired emotion. With unknown text, however, a TTS system does not know the context or prosody of a sentence, and therefore has an inherent difficulty in realizing changes in emotion.

However, emotion and prosody are easily reconciled for individual words and known text. For example, prosody information can be encoded with generic messages that are standard on a mobile device. A standard message that announces a new email received or caller identification on a mobile device is known by both the client and the server. When the user customizes the emotion of synthesized voice for standard messages, the system can apply the emotion criteria to the prosody information which is already known in order to generate the target voice. Additionally, the user may desire that only certain words, or combinations of words, are synthesized with selected emotion criteria. The system can apply the emotion criteria directly to the relevant words, disregarding prosody, and still achieve the desired effect.

In an alternative embodiment, the user may select different intuitive criteria for different TTS functions on the same device. For example, may wish to have the voice for email or text messages to be relatively emotionless and constant. In such messages, content may be more important to the user than the method of delivery. For other messages, however, such as caller announcements and new email notification, the user may wish to be alerted by an excited or energetic voice. This allows the user to audibly distinguish between different types of messages.

In another embodiment, the user may select intuitive criteria which alter the speaking style or vocabulary of the synthesized voice. These criteria would not affect text messages or email so content could be accurately preserved. Standard messages, however, such as caller announcements and new email notifications, could be altered in such a fashion. For example, the user may wish to have announcements delivered in a polite fashion using formal vocabulary. Alternatively, the user may wish to have announcements delivered in an informal manner using slang or casual vocabulary.

Another option is to provide criteria relating to selecting a specific synthesized voice which will resemble a well-known person, such as a newscaster or entertainer. The user may browse a catalog of specific voices with the selection interface. The specific synthesized voice desired by the user is stored on the server. When the user selects the specific voice, the server extracts the necessary characteristics from the voice already on the server. These characteristics are downloaded to the client, which uses the characteristics to generate the desired synthesized voice. Alternatively, the server may store only the necessary characteristics for a specific voice rather than the entire voice.

The intuitive criteria may be arranged in a hierarchical menu that the user navigates with the selection interface. The menu may present options such as male or female to the user. After the user makes a selection, the menu presents another option, such as perceived age of the synthesized voice. Alternatively, the hierarchical menu may be controlled remotely by the server. As the user makes selections from the intuitive criteria, the server updates the menu dynamically in step 18 to incorporate the choices available for a particular voice customization. As the user makes selections, the server may eliminate specific criteria which are incompatible with criteria already selected by the user.

The intuitive criteria may be presented to the user as slidable bars which represent the degree of customization available for a particular criterion. The user adjusts the bars within the presented limits to achieve the desired level of customization for a criterion. For example, one possible implementation utilizes a slidable bar to vary the degree of masculinity and femininity of the synthesized voice. The user may make the synthesized voice either more masculine or more feminine depending on the location of the slidable bar. Alternatively, similar function may be achieved using a rotatable wheel.

The intuitive criteria selected by the user are uploaded to the server in step 16. The server uses the criteria to determine the target synthesized voice in step 20. Once the parameters necessary for customization are established, the server downloads the results to the client in step 22. The user may be charged a fee for the ability to download customized voices as shown in step 24. The fee could be implemented as a monthly charge or on a per-use basis. Alternatively, the server may provide a sample rendition of a targeted voice to the user. As the user selects a particular criterion, the server downloads a brief sample so the user can determine if the selected criterion is satisfactory. Additionally, the user may listen to a sample voice that is representative of all selected criteria.

One category of intuitive criteria relates to word pronunciation, particularly in relation to dialect and its effect on word pronunciation. For example, a user may select criteria that will customize the synthesized voice to have a Boston or Southern accent. In one embodiment, a complete language with the customized pronunciation characteristics is downloaded to the client. In another embodiment, only the data necessary to transform the language to the desired pronunciation is downloaded to the client.

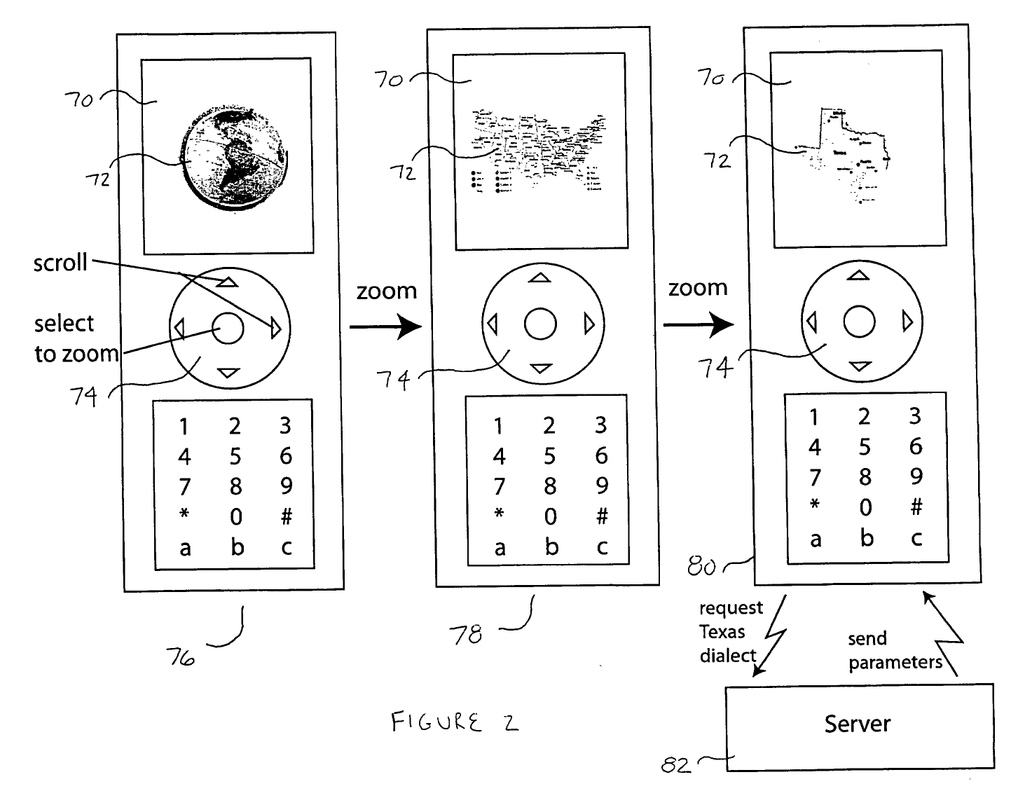

Alternatively, a geographical representation of synthesized voices may be presented in the form of an interactive map or globe as shown in FIG. 2. If an accent which is characteristic of a particular location is desired, the user may manipulate a geographical representation 72 of the globe or map on the GUI 70 to highlight the appropriate location. For example, if the user desires a synthesized voice with a Texan dialect, the geographical representation 72 may be manipulated using the selection interface 74 until a particular region in Texas is highlighted. The geographical representation 72 begins as a globe at the initial level 76. The user traverses to the next level of the geographical representation 72 by using the selection interface 74. An intermediate level 78 of the geographical representation 72 is more specific, such as a country map. The final level 80 is a specific representation of a geographic region, such as the state of Texas. The user confirms the selection using the selection interface 74 and the data is exchanged with the server 82. Such a geographical selection may be available in lieu of, or in addition to, other intuitive criteria.

The intuitive criteria that are selected by the user may be visually represented on the mobile device using other methods as well. In one embodiment, the criteria are selected and represented on the mobile device according to various colors. The user varies the intensity or hue of a given color, which represents a particular criterion. For example, high emotion may correspond to bright red, while less emotion may correspond to a dull brown. Similarly, lighter colors may represent a younger voice, while darker colors represent an older voice.

In another embodiment, the intuitive criteria that the user selects are represented as an icon or cartoon character on the mobile device. Emotion criteria may alter the facial expressions of the icon, while gender criteria cause the icon to appear as a male or female. Other criteria may affect the clothing, age, or animation of the icon.

In still another embodiment, the intuitive criteria are displayed as two or three-dimensional spatial representations. For example, the user may manipulate the spatial representation in a manner similar to the geographical selection method discussed above. The user may select a position in a three-dimensional spatial representation to indicate degrees of emotion or gender. Alternatively, criteria may be paired with one another and represented as a two-dimensional plane. For example, age and gender criteria may be represented on such a plane, wherein vertical manipulation affects the age criterion and horizontal manipulation affects the gender criterion.

The user may wish to download a complete language for a synthesized voice. For example, the user may select criteria to have all TTS messages delivered in Spanish instead of English. Alternatively, the user may use the above geographical selection method. The language change may be permanent or temporary, or the user may be able to switch between downloaded languages selectively. In one embodiment, the user may be charged a fee for each language downloaded to the client.

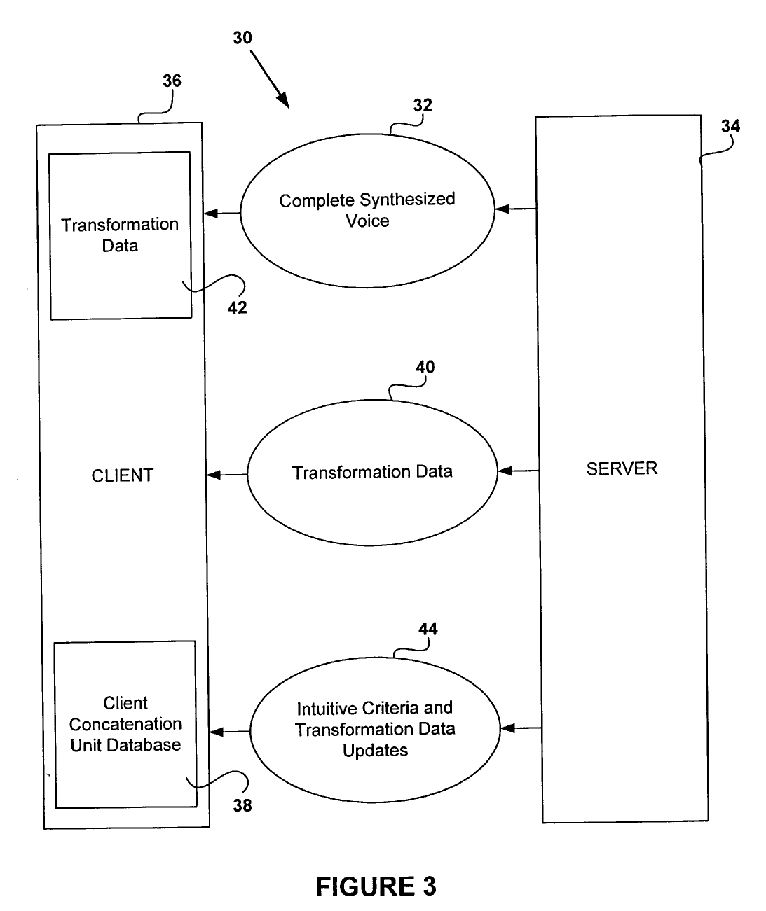

As demonstrated in FIG. 3, several embodiments for the structure of the distributed architecture 30 are conceivable. If the user desires a high degree of quality and accuracy for the selected criteria, a complete synthesized database 32 is downloaded from the server 34. The complete synthesized voice is created on the server 34 according to the intuitive criteria and sent to the client 36 in the form of a concatenation unit database. In this embodiment, efficiency is sacrificed due to the greater length of time necessary to download the complete synthesized voice to the client 36.

Still referring to FIG. 3, the concatenation unit database 38 may reside on the client 36. When the user selects intuitive criteria, the server 34 generates transformation data 40 according to the criteria and downloads the transformation data 40 to the client 36. The client 36 applies the transformation data 40 to the concatenation unit database 38 to create the target synthesized voice.

Referring once more to FIG. 3, the concatenation unit database 38 may reside on the client 36 in addition to resources 42 necessary for generating transformation data. The client 36 communicates with the server 34 primarily to receive updates 44 concerning transformation data and intuitive criteria. When new criteria and transformation parameters become available, the client 36 downloads the update data 44 from the server 34 to increase the range of customization for voice synthesis. Additionally, the ability to download new intuitive criteria may be available in all disclosed embodiments.

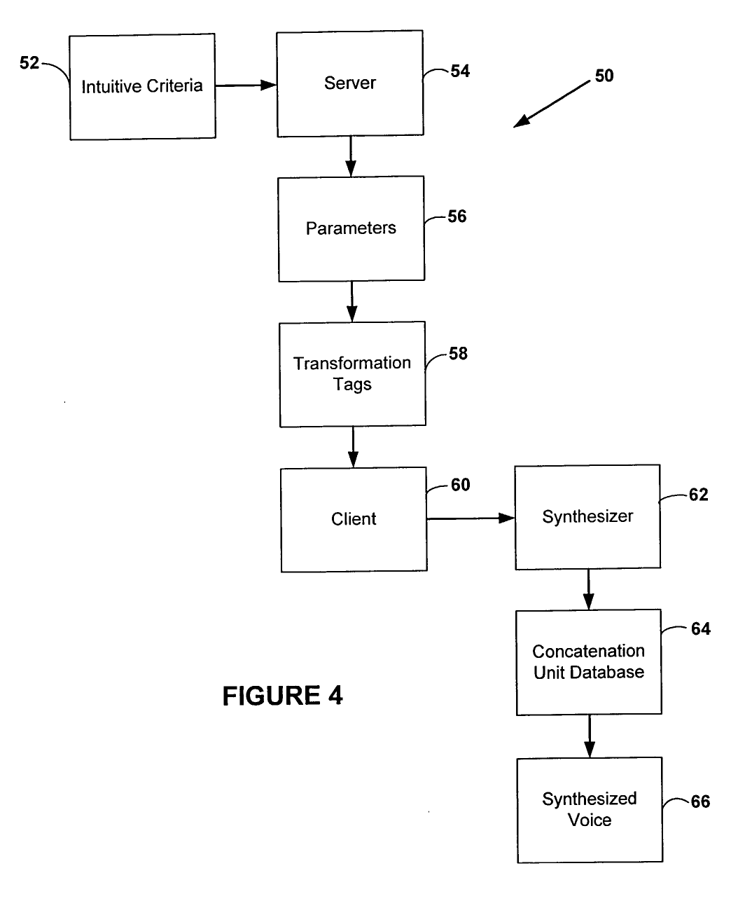

Referring now to FIG. 4, the client-server architecture 50 wherein transformation data for synthesizer customization is downloaded to the client 60 is shown. While the user chooses voice customization based on intuitive criteria 52, the server 54 must use the intuitive criteria 52 to generate transformation data for the actual synthesis. The server 54 receives the selected criteria 52 from the client 60 and maps the criteria 52 to a set of parameters 56. Each criterion 52 corresponds to parameters 56 residing on the server. For example, a particular criterion selected by the user may require parameter variance in amplitude and formant frequencies. Possible parameters may include, but are not limited to, pitch control, intonation, speaking rate, fundamental frequency, duration, and control of the spectral envelope.

The server 54 establishes the relevant parameters 56 and uses the data to generate a set of transformation tags 58. The transformation tags 58 are commands to a voice synthesizer 62 on the client 60 that designate which parameters 56 are to be modified, and in what manner, in order to generate the target voice. The transformation tags 58 are downloaded to the client 60. The synthesizer modifies its settings, such as pitch value, speed, or pronunciation, according to the transformation tags 58. The synthesizer 62 generates the synthesized voice 66 according to the modified settings as applied to the concatenation unit database 64 already residing on the mobile device. The synthesizer 62 applies the transformation tags 58 as the server 54 downloads the transformation tags 58 to the client 60.

The transformation tags 58 are not specific to a particular synthesizer. The transformation tags 58 may be standardized to be applicable to a wide range of synthesizers. Hence, any client 60 interconnected with the server 54 may utilize the transformation tags 58, regardless of the synthesizer implemented on the mobile device.

Alternatively, certain aspects of the synthesizer 62 may be modified independently of the server 54. For example, the client 60 may store a database of downloaded transformation tags 58 or multiple concatenation unit databases. The user may then choose to alter the synthesized voice based on data already residing on the client 60 without having to connect to the server 54.

In another embodiment, a message may be pre-processed for synthesis by the server before arriving on the client. Typically any text messages or email messages are sent to the server, which subsequently sends the messages to the client. The server in the present invention may apply initial transformation tags to the text before sending the text to the client. For example, parameters such as pitch or speed may be modified on the server, and further modifications, such as pronunciation, may be applied at the client.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for supplying customized synthesized voice data to a user comprising:
capturing voice criteria from a user at a first computing device, the voice criteria being indicative of desired characteristics of a synthesized voice;
communicating the voice criteria to a second computing device, the second computing device interconnected via a network to the first computing device; and
generating synthesized voice rules at the second computing device corresponding to the captured voice criteria and communicating the synthesized voice rules to the first computing device.

2. The method according to claim 1 further comprising assessing a fee to the user.

3. The method according to claim 2 wherein the fee is assessed to the user according to the synthesized voice rules communicated to the first computing device.

4. The method according to claim 2 wherein the fee is assessed to the user according to a designated time period.

5. The method according to claim 1 wherein the first computing device is a client and the second computing device is a server.

6. The method according to claim 5 wherein the client is a mobile phone.

7. The method according to claim 5 wherein the client is a personal data assistant.

8. The method according to claim 5 wherein the client is a personal organizer.

9. The method according to claim 1 wherein the synthesized voice rules are a concatenation unit database.

10. The method according to claim 1 further comprising communicating update data from the second computing device to the first computing device, wherein the update data represents adjustments to capturable voice criteria.

11. A method for customizing a synthesized voice in a distributed speech synthesis system, comprising:
capturing voice criteria from a user at a first computing device, the voice criteria being indicative of desired characteristics of a synthesized voice;
communicating the voice criteria to a second computing device, the second computing device interconnected via a network to the first computing device;
generating a set of synthesized voice rules at the second computing device based on the voice criteria, the set of synthesized voice rules representing prosodic aspects of the synthesized voice; and
communicating the set of synthesized voice rules to the first computing device.

12. The method according to claim 11 wherein the set of synthesized voice rules represent voice quality of the synthesized voice.

13. The method according to claim 11 wherein the set of synthesized voice rules represent pronunciation behavior of the synthesized voice.

14. The method according to claim 11 wherein the set of synthesized voice rules represent speaking style of the synthesized voice.

15. The method according to claim 11 wherein capturing voice criteria from a user includes selecting desired characteristics of a synthesized voice according to a hierarchical menu of voice criteria.

16. The method according to claim 15 wherein the second computing device modifies the voice criteria available on the hierarchical menu according to previously selected voice criteria.

17. The method according to claim 11 wherein capturing voice criteria from a user includes selecting desired characteristics of a synthesized voice according to geographic location.

18. The method according to claim 11 wherein the first computing device is a client and the second computing device is a server.

19. The method according to claim 18 wherein the client is a mobile phone.

20. The method according to claim 18 wherein the client is a personal data assistant.

21. The method according to claim 18 wherein the client is a personal organizer.

22. The method according to claim 11 wherein the voice criteria are indicative of pronunciation behavior of a synthesized voice.

23. The method according to claim 22 wherein the voice criteria are further indicative of dialect of a synthesized voice.

24. The method according to claim 11 wherein the synthesized voice rules are a concatenation unit database.

25. The method according to claim 11 further comprising communicating update data from the second computing device to the first computing device, wherein the update data represents adjustments to capturable voice criteria.

26. A method for generating a synthesized voice in a distributed speech synthesis system according to criteria selected by a user comprising:
capturing voice criteria from a user at a first computing device, the voice criteria being indicative of desired characteristics of a synthesized voice;
communicating the voice criteria to a second computing device, the second computing device interconnected via a network to the first computing device;
mapping the voice criteria to parameters determinant of voice characteristics;
generating a set of tags indicative of transformations to the parameters, wherein the transformations to the parameters represent the captured voice criteria;
communicating the set of tags to the first computing device; and
generating a synthesized voice according to the set of tags.

27. The method according to claim 26 comprising generating a synthesized voice according to a set of tags at the second computing device and communicating the synthesized voice to the first computing device.

28. The method according to claim 26 wherein the steps of mapping the voice criteria to parameters determinant of voice characteristics, generating a set of tags indicative of transformations to the parameters, and generating a synthesized voice according to the set of tags transpire on the first computing device.

29. The method according to claim 28 further comprising communicating update data from the second computing device to the first computing device, wherein the update data represents adjustments to capturable voice criteria.
